(19) United States
(12) Patent Application Publication
(10) Pub. No.: US 2010/0162132 A1
(43) Pub. Date: Jun. 24, 2010

(54) TECHNIQUES TO MANAGE AND DISPLAY RELATED COMMUNICATIONS

(75) Inventors: Sandhya Vankamamidi, Hyderabad (IN); Sutirtha Saha, Hyderabad (IN); Abhishek K. Gupta, Hyderabad (IN); Kaladhar Bapu, Hyderabad (IN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/342,937

(22) Filed: Dec. 23, 2008

(51) Int. Cl. G06F 3/048; G06F 15/16

(52) U.S. Cl. 715/752; 709/206

(57) ABSTRACT

Techniques to manage and display related communications are described. A system may comprise a communication management tool (CMT) operative on a computer, the CMT comprising a threading component operative to associate a plurality of communications from a plurality of communication types with a conversation thread, and a display component operative to display communications in a conversation thread as a conversation view. Other embodiments are described and claimed.

### BACKGROUND

Various computer-implemented tools allow users to keep track of communication with others. Some email clients, for example, can group email messages around a subject. Customer Relationship Management (CRM) tools allow customer support personnel to track a series of interactions with a customer about a service issue. In reality, however, conversations are rarely confined to only one communication channel. For example, an email message may prompt a phone call, or a customer may need to send or receive information by fax to continue a conversation.

It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to manage and display related communications. Some embodiments are particularly directed to techniques to manage and display related communications for a Customer Relationship Management (CRM) applications and tools. In one embodiment, for example, a computer implemented system may comprise a communication management tool (CMT) operative on a computer, the CMT comprising a threading component operative to associate a plurality of communications from a plurality of communication types with a conversation thread, and a display component operative to display communications in a conversation thread as a conversation view. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a first system.

FIG. 2 illustrates an embodiment of a distributed system.

FIG. 3 illustrates an embodiment of a logic flow.

FIG. 4 illustrates an embodiment of a view.

FIG. 5 illustrates an embodiment of a logic flow.

FIG. 6 illustrates an embodiment of a logic flow.

FIG. 7 illustrates an embodiment of a computing architecture.

FIG. 8 illustrates an embodiment of a communications architecture.

### DETAILED DESCRIPTION

Various embodiments are directed to techniques for managing related communications from a variety of channels. Conventionally, communications that occur in different channels may be grouped separately, breaking up the conversational components. Some conventional tools may also group all communications together, without distinguishing to which conversation the communication belongs.

Embodiments may group communications about a particular topic together in one thread, and may display the thread as a conversation. As a result, the embodiments can improve understanding of the context of a conversation by logically grouping all of the related communications together. The embodiments may also improve efficiency, productivity and effectiveness of the user.

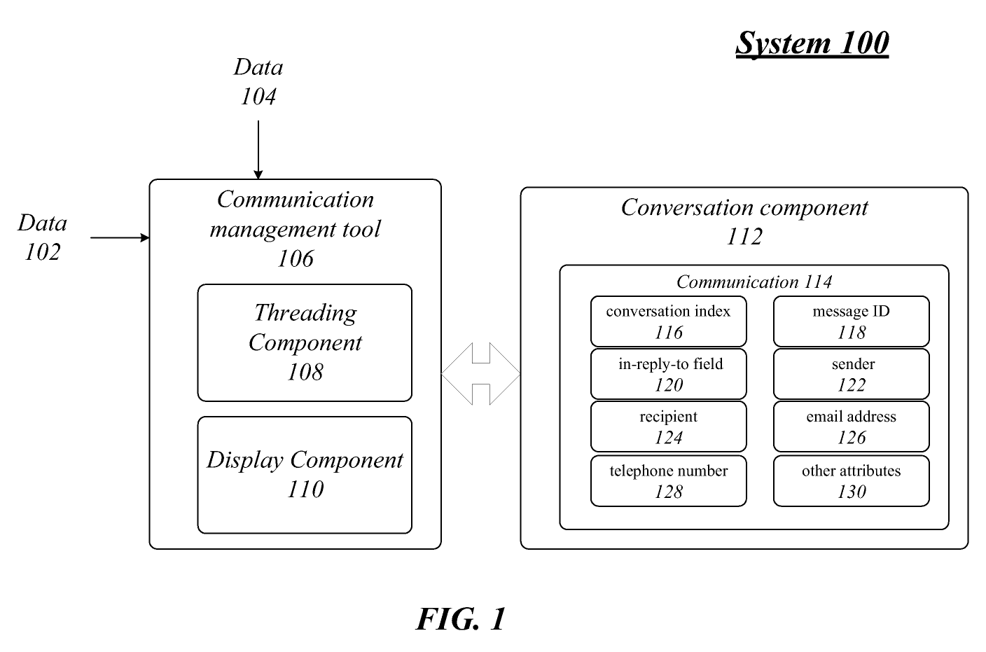

FIG. 1 illustrates a block diagram for a system 100 to manage and display related communications. In one embodiment, for example, the system 100 may comprise a computer-implemented system 100 having a communication management tool 106 which may have multiple components 108, 110, 112. As used herein the terms “system”, “tool” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components 108, 110, 112 may be communicatively coupled via various types of communications media. The components 108, 110, 112 may coordinate operations between each other. The coordination may involve the uni-directional or bi-directional exchange of information. For instance, the components 108, 110, 112 may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In an embodiment, system 100 may include a communication management tool (CMT) 106 operative on a computer. CMT 106 may include a threading component 108 and a display component 110. Threading component 108 may receive communication data 102, 104 from a variety of communication types, and may associate the communications with a conversation component 112. Display component 110 may organize and display the related communications in a conversation as a conversation view.

Threading component 108 may create and maintain a conversation component 112, also referred to herein as a conversation. A conversation may include one or more communications 114. A communication 114 may include data in the form of, for example, an email message, an instant message, a telephone call, a voicemail message, a fax, a text message, a chat message, a task, an appointment, or a webinar comment. Threading component 108 may assign or store attributes with communication 114. Possible attributes may include a conversation index 116, a message identifier (ID) 118, an in-reply-to field 120, a sender 122, a recipient 124, an email address 126, or a telephone number 128. Other attributes 130 may also be stored or assigned to a communication, for example, a time/date stamp, a priority, a title, a customer ID, a user-assigned attribute, etc.

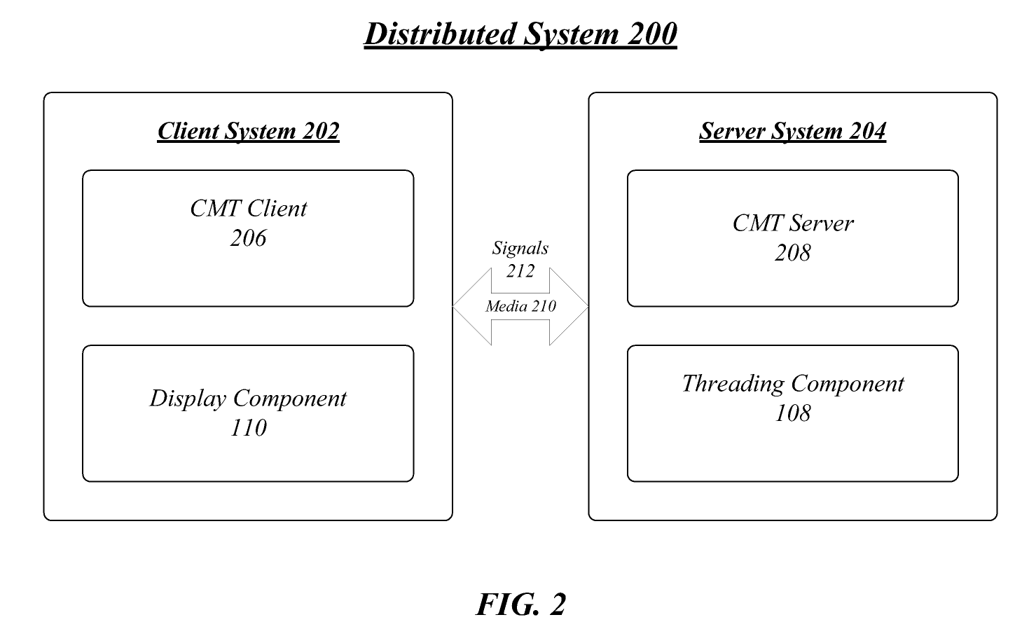

FIG. 2 illustrates a block diagram of a distributed system 200 to manage and display related communications. The distributed system 200 may distribute portions of the structure and/or operations for the system 100 across multiple computing entities. Examples of distributed system 200 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, for example, the distributed system 200 may be implemented as a client-server system. A client 202 may implement a CMT client 206 and display component 110. A server 204 may implement a CMT server 208 and threading component 108. Client 202 and server 204 may communicate with each over a communications media 210 using communications signals 212. In one embodiment, for example, the communications media may comprise wireless signals. In one embodiment, for example, the communications signals 322 may comprise wired signals.

CMT server 208 may create and maintain stored communications and conversations on one or more server computers. CMT server 208 may provide an interface to CMT client 206 such that a CMT user may view and manipulate CMT data remotely from server system 204. Threading component 108 may be a component of CMT server 208, or may be a separate component accessible to CMT server 208, such as but not limited to, a library routine, or an applet.

Display component 110 may be a component of CMT client 206, or may be a separate component accessible to CMT client 206, such as, but not limited to, a library routine, or an applet.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

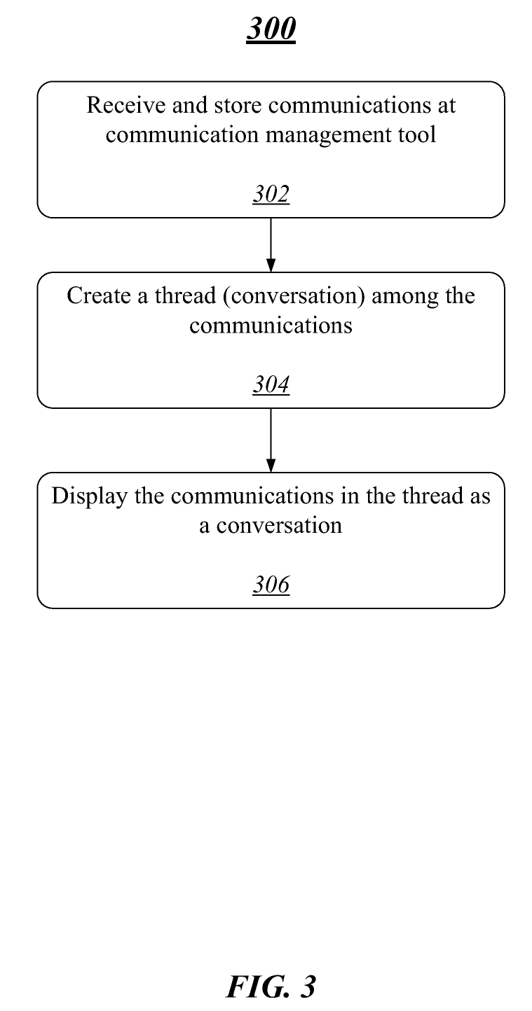

FIG. 3 illustrates one embodiment of a logic flow 300. The logic flow 300 may be representative of some or all of the operations executed by one or more embodiments described herein.

In the illustrated embodiment shown in FIG. 3, the logic flow 300 may receive and store one or more communications at block 302. For example, a CMT user may receive an email from a client, and CMT 106 may store or otherwise record a location for the email. In another example, a CMT user may create a record of a phone conversation, which CMT 106 may receive and store as a communication. Embodiments are not limited to these examples.

The logic flow 300 may create a thread, also referred to herein as a conversation, among related communications. For example, threading component 108 may use one or more attributes of a communication to identify commonalities. For example, communications having the same value in the in-reply-to field 120 may be grouped as a thread. Related communications may be assigned the same conversation index 116, for example, or may have related message IDs 118. Threading component 108 may use any or all of the communication attributes to identify related communications.

The logic flow 300 may display the communications in a thread as a conversation view at block 306. For example, display component 110 may display an ordered grouping of some or all of the communications in a conversation or thread.

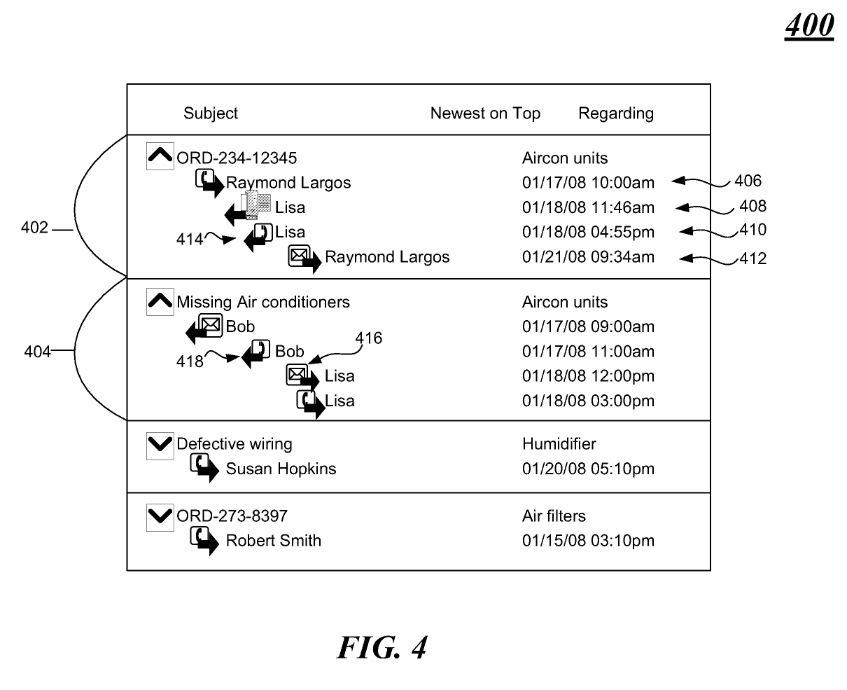

FIG. 4 illustrates an embodiment of a conversation view 400. Conversation view 400 shows four conversations, for example, conversation 402 and 404. Conversation 402 contains a telephone call communication 406 from “Raymond Largos”, a fax communication 408 from “Lisa” in response to communication 406, a telephone call communication 410 from Lisa in response to communication 406, and an email communication 412 from Raymond Largos in response to communication 410.

Display component 110 may display communications of a conversation with indentation to indicate the relationships among the communications. For example, communication 408 is indented from communication 406, indicating that communication 408 was made in response to communication 406. Display component 110 may display a communication with an icon that represents the type of communication. For example, icon 414 indicates a telephone call communication, and icon 416 indicates an email communication. Display component 110 may display a directionality indicator with each communication to illustrate the sender. Conversation view 400, for example, uses arrow icon 418 to indicate a communication from “Bob.” Embodiments are not limited to these examples.

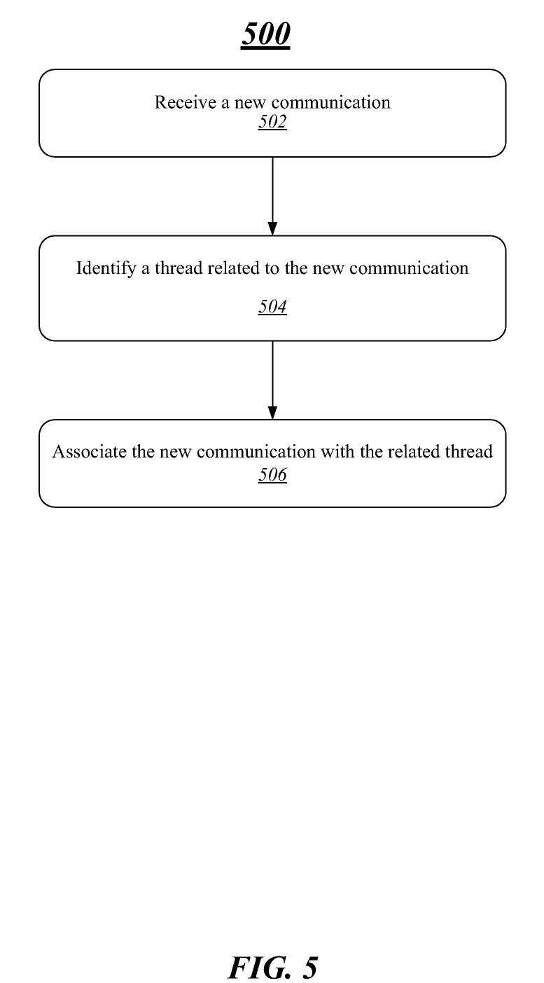

FIG. 5 illustrates one embodiment of a logic flow 500. The logic flow 500 may be representative of some or all of the operations executed by one or more embodiments described herein.

In the illustrated embodiment shown in FIG. 5, the logic flow 500 may receive a new communication at block 502. At block 504, the logic flow may identify a thread related to the new communication. For example, threading component 108 may use one or more of the communication attributes to identify a related thread. In an embodiment, threading component 108 may accept user input to identify a related thread. In particular, user input may be used to identify a thread when a communication is not normally received with sufficient identifying attributes. For example, an email message usually has a sender, a recipient, a subject, and other header information that may allow the threading component to locate the related thread automatically, or by hashing the email message. On the other hand, a telephone call may only have a telephone number, which may not be sufficient to identify the related thread. In such cases, the CMT user may enter some attribute information manually in order to allow the threading component 108 to identify the related thread.

In block 506, the logic flow 500 may associate the new communication with the related thread. For example, threading component 108 may assign a conversation index 116 to the new communication to associate the new communication with the related thread.

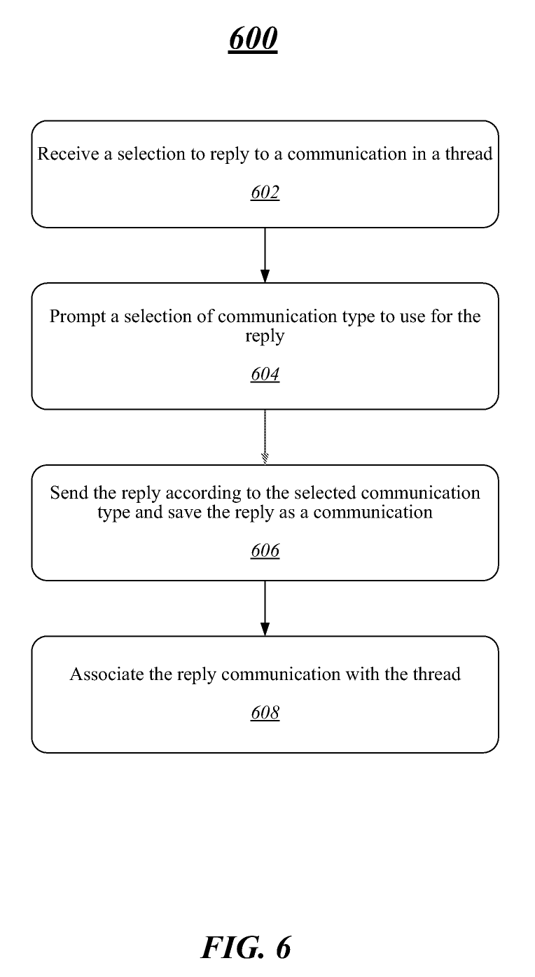

FIG. 6 illustrates one embodiment of a logic flow 600. The logic flow 600 may be representative of some or all of the operations executed by one or more embodiments described herein.

In the illustrated embodiment shown in FIG. 6, the logic flow 600 may receive a selection to reply to a communication in a thread at block 602. For example, referring to FIG. 4, a user may select a communication, such as communication 412, and may choose to reply to the selected communication.

The logic flow, in block 604, may prompt the user to select a communication type to use for the reply. For example, display component 110 may prompt the user with a dialog box, a pop-up menu or the like. Communication types may include a telephone call, an email, an instant message, a fax, etc.

The logic flow in block 606 may send a reply communication according to the selected communication type and save the reply as a communication 114. In an embodiment, CMT 106 may send a reply communication directly, for example, by allowing the user to compose an email and send it via CMT 106. Alternatively, CMT 106 may store a communication, for example, a phone call communication record entered by a user where the actual phone call is placed outside of CMT 106.

The logic flow may associate the reply communication with the thread in block 608. Block 608 may be analogous to block 506.

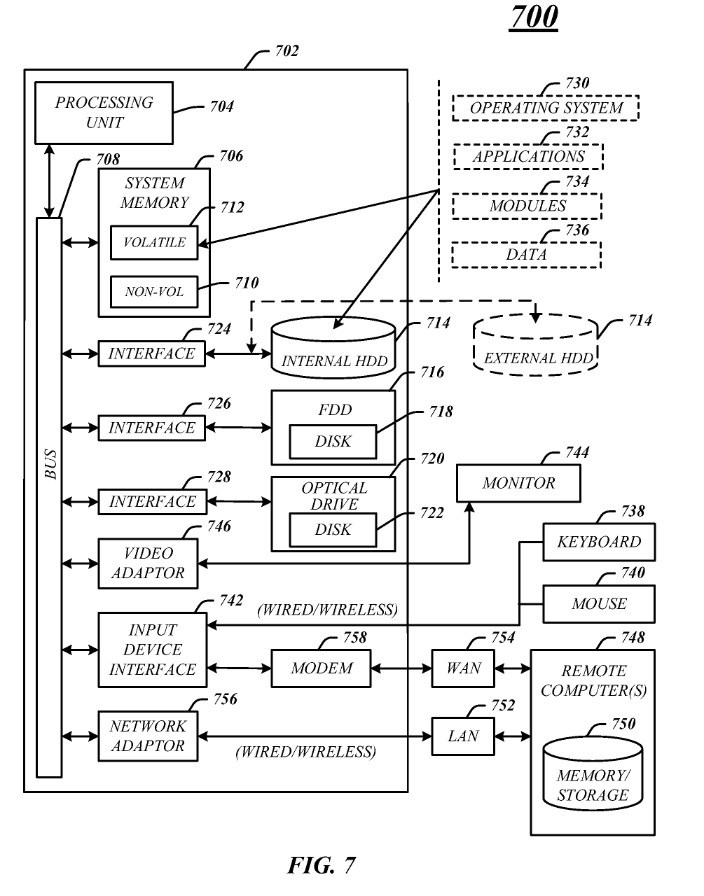

FIG. 7 illustrates an embodiment of an exemplary computing architecture 700 suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, the CMT 106, threading component 108, display component 110, or conversation component 112.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

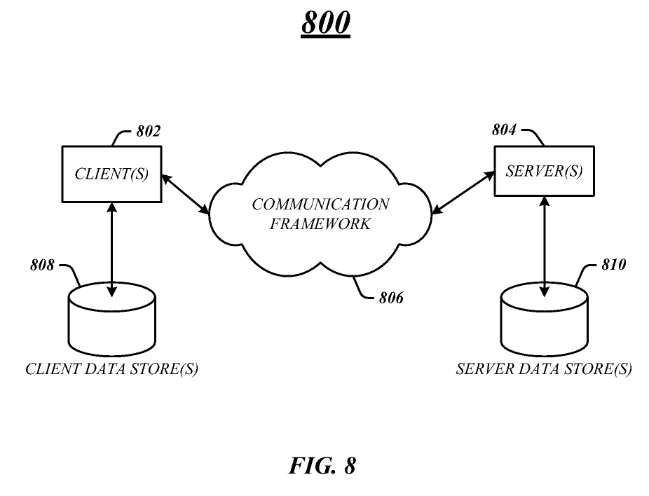

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 8, the communications architecture 800 comprises includes one or more clients 802 and servers 804. The clients 802 may implement the client system 202. The servers 804 may implement the server system 204. The clients 802 and the servers 804 are operatively connected to one or more respective client data stores 808 and server data stores 810 that can be employed to store information local to the respective clients 802 and servers 804, such as cookies and/or associated contextual information. In particular, server data stores 810 may store communications 114.

The clients 802 and the servers 804 may communicate information between each other using a communication framework 806. The communications framework 806 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 802 and the servers 804 may include various types of standard communication elements designed to be interoperable with the communications framework 806, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 802 and a server 804 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
storing communications received from a plurality of communication types via a communication management tool (CMT);
creating a thread among the communications; and
displaying the communications in the thread as a conversation.

2. The method of claim 1, wherein a communication comprises at least one of: an email message, an instant message, a telephone call, a voicemail message, a fax, a text message, a chat message, a task, an appointment, or a webinar comment.

3. The method of claim 1, further comprising:
receiving a new communication;
identifying a thread related to the new communication; and
associating the new communication with the related thread.

4. The method of claim 3, further comprising:
identifying a thread for the new communication using at least one of: a conversation index, a message ID, an in-reply-to field, a sender, a recipient, an email address, a telephone number, or a user selection of a thread.

5. The method of claim 1, further comprising:
displaying a communication with an icon representing a communication type.

6. The method of claim 1, further comprising:
displaying a communication with a directionality indicator.

7. The method of claim 1, further comprising:
receiving a selection of a communication to reply to in a thread;
prompting a selection of a communication type to use for the reply;
saving the reply according to the selected communication type as a communication; and
associating the reply communication with the thread.

8. The method of claim 1, wherein the CMT is a customer relationship management application.

9. A computer implemented system, comprising:
a communication management tool (CMT) operative on a computer, the CMT comprising:
a threading component operative to associate a plurality of communications from a plurality of communication types with a conversation thread; and
a display component operative to display communications in a conversation thread as a conversation view.

10. The system of claim 9, wherein a communication comprises at least one of: a conversation index, a message ID, an in-reply-to field, a sender, a recipient, an email address, or a telephone number.

11. The system of claim 9, wherein a communication type comprises at least one of: email, an instant message, a telephone call, a voicemail message, a fax, a text message, a chat message, a task, an appointment, or a webinar comment.

12. The system of claim 9, wherein the threading component is further operative to receive a new communication;
identify if a conversation thread exists for the new communication;
create a new conversation thread when no conversation thread exists for the new communication; and
associate the new communication with an existing conversation thread.

13. The system of claim 9, wherein the display component is further operative to at least one of:
display a communication with an icon representing a communication type; or display a communication with a directionality indicator.

14. The system of claim 9, wherein the CMT is a customer relationship management application.

15. An article comprising a storage medium comprising instructions that if executed enable a system to:
store communications received from a plurality of communication types;
create a thread among the communications; and
display the communications in the thread as a conversation.

16. The article of claim 15, wherein a communication comprises at least one of: an email message, an instant message, a telephone call, a voicemail message, a fax, a text message, a chat message, a task, an appointment, or a webinar comment.

17. The article of claim 15, the medium further comprising instructions that if executed enable the system to:
receive a new communication;
identify a thread related to the new communication; and
associate the new communication with the related thread.

18. The article of claim 17, the medium further comprising instructions that if executed enable the system to:
identify a thread for the new communication using at least one of: a conversation index, a message ID, an in-reply-to field, a sender, a recipient, an email address, a telephone number, or a user selection of a thread.

19. The article of claim 15, the medium further comprising instructions that if executed enable the system to at least one of:
display a communication with an icon representing a communication type; or
display a communication with a directionality indicator.

20. The article of claim 15, the medium further comprising instructions that if executed enable the system to:
receive a selection of a communication to reply to in a thread;
prompt a selection of a communication type to use for the reply;
save the reply according to the selected communication type as a communication; and
associate the reply communication with the thread.
